(19) United States
(12) Patent Application Publication
(10) Pub. No.: US 2021/0340332 A1
(43) Pub. Date: Nov. 4, 2021

(54) METHOD FOR PRODUCING AROMATIC POLYETHERSULFONES CONTAINING ISOHEXIDE

(71) Applicants: ROQUETTE FRERES, Lestrem (FR); UNIVERSITE CLAUDE BERNARD LYON 1, Villeurbanne (FR); CENTRE NATIONAL DE LA RECHERCHE SCIENTIFIQUE -CNRS -, Paris (FR)

(72) Inventors: Nicolas JACQUEL, Lambersart (FR); Sarah DEGRAS, Villeurbanne (FR); Régis MERCIER, IRIGNY (FR); Thierry DELAUNAY, Chenehutt (FR)

(21) Appl. No.: 17/269,662

(22) PCT Filed: Aug. 20, 2019
(86) PCT No.: PCT/FR2019/000137

§ 371 Date: Feb. 19, 2021

(30) Foreign Application Priority Data
Aug. 20, 2018 (FR) 18 57545

(51) Int. Cl. C08G 81/00; C08G 65/40; C08G 75/23; C08K 5/1535

(52) U.S. Cl. CPC C08G 81/00; C08K 5/1535; C08G 75/23; C08G 65/4056

(57) ABSTRACT

The present invention relates to a method for producing a block copolymer of the poly-ethersulfone type containing a biosourced diol, to a block copolymer that can be obtained by said method, and to the use of said block copolymer for producing membranes.

### FIELD OF THE INVENTION

The present invention relates to a process for the preparation of a block copolymer of polyethersulfone type based on a biobased diol, to a block copolymer capable of being obtained by said process, as well as to the use of said block copolymer for the manufacture of membranes.

### STATE OF THE ART

Polyethersulfones are thermoplastic polymers, in particular well known for their temperature stability. They also exhibit good resistance to hydrolysis, which makes it possible to use them in medical applications, for example requiring sterilization in an autoclave. These polymers are also used for the manufacture one of the membranes, with control of the size of the pores down to 40 nanometers. Such membranes can he used in applications such as hemodialysis, wastewater recovery, food and beverage processing, and gas separation.

Isohexides, or 1,4:3,6-dianhydrohexitols, are rigid bicyclic chiral diols resulting from sugars. In particular, isosorbide is obtained from the double dehydration reaction of sorbitol, itself resulting from the hydrogenation reaction of glucose. Isohexides constitute intermediates of choice in the synthesis of many compounds which have their applications in various fields, such as that of the plastics industry, thus replacing their counterparts resulting from the petrochemical industry. Isohexides can be used for the manufacture of specialty polymers of polyethersulfone type, “high-performance” polymers having as main application liquid- and gas-phase separation membranes.

Thus, Kricheldorf et al. first described the preparation and the characterization of isosorbide-containing polyethersulfones from silylated isosorbide and difluorodiphenylsulfone (H. Kricheldorf et al., J. Polymer Sci., Part A: Polym. Chem., 1995, 33, 2667-2671). Since silylated isosorbide is expensive, Kricheldorf and Chatti modified their polymerization conditions and have described the synthesis of isosorbide-containing polyethersulfones from nonfunctionalized isosorbide and difluorodiphenylsulfone (S. Chatti et al., High Perform. Polym., 2009, 21, 105-118).

The patent application WO 2014/072473 describes the synthesis of polyethersulfones containing in particular a 1,4:3,6-dianhydrohexitol chosen from isosorbide, isomannide and isoidide, and a dihaloaryl monomer.

Belgacem et al. subsequently described the synthesis of polyethersulfones containing a 1,4:3,6-dianhydrohexitol and bisphenol A from difluorodiphenylsulfone, a 1,4:3,6-dianhydrohexitol and bisphenol A as monomers reacted together in the same reaction medium (Belgacem et al., Des. Monomers Polym., 2016, 19, 248-255). Under these conditions, the polymer obtained is a statistical copolymer in which the sequence of units containing 1,4:3,6-dianhydrohexitol and bisphenol A is random.

The application US 2017/0240708 also describes the synthesis of polyethersulfones containing a 1,4:3,6-dianhydrohexitol and bisphenol A by a similar process. The polyethersulfone obtained is a statistical copolymer based on bisphenol A and isosorbide.

However, generally speaking, the desire remains of a person skilled in the art to enrich the library of polymers of polyethersulfone type obtained from a biobased compound, in an approach to economize on fossil materials in favor of biobased raw materials.

There also exists a need to provide polymers of the polyethersulfone type, exhibiting characteristics suitable for using them in the manufacture of membranes. These characteristics are, for example, high number-average molecular weights (Mn), which are necessary for obtaining film-forming properties. These polymers can also advantageously exhibit a high hydrophilicity: in the case of a membrane, the latter will become wet quickly, which results in rapid filtration with high flow rates and yields. Finally, these polymers can also exhibit properties of permeability, and in particular of selectivity with respect to certain gases and/or liquids, which can prove to be particularly advantageous, in membrane filtration processes.

### SUMMARY OF THE INVENTION

The present invention relates to a process for the preparation of a block copolymer of aromatic polyethersulfone type comprising the following successive stages:
a) preparation of a first polymer block having the repeat unit:

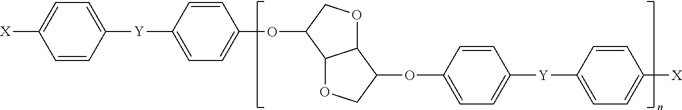

with a number-average molar mass Mn of between 1000 and 30 000 g/mol and where n is an integer greater than 1 and X is Cl or F and Y is CO or SO₂,
the preparation of said first block consisting of the reaction between a 1,4:3,6-dianhydrohexitol and an excess of 4,4′-dichlorodiphenyl sulfone or of 4,4′-difluorodiphenyl sulfone or of 4,4′-difluorodiphenyl ketone or of 4,4′-dichlorodiphenyl ketone in the presence of a base in an organic solvent,
b) preparation of a second polymer block having the repeat unit:

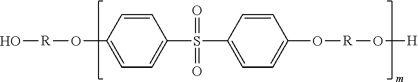

with a number-average molar mass Mₙ of between 1000 and 30 000 g/mol and where m is an integer greater than 1 and R originates from an aromatic or aliphatic diol,
the preparation of this second block consisting of the reaction between an aromatic or aliphatic diol in excess or in a stoichiometric amount with 4,4′-dichlorodiphenyl sulfone or 4,4′-difluorodiphenyl sulfone in the presence of a base in an organic solvent and optionally a cosolvent,
c) reaction between the first block and the second block according to block copolymerization in two successive stages or block copolymerization in two distinct stages.

The expression “block copolymerization in two successive stages” means that, on conclusion of the second stage of the process, the first block and the second block are present in the same reaction medium. The third stage of the process consists in increasing the temperature of the reaction medium comprising the first block and the second block so that the two blocks react together.

In the “block copolymerization in two distinct stages”, the third stage of the process consists in bringing the first polymer block obtained on conclusion of the first stage of the process into the presence of the second polymer block obtained on conclusion of the second stage of the process so that the first block and the second block react together.

The invention also relates to a block copolymer of aromatic polyethersulfone type capable of being obtained by said process. This copolymer comprises the repeat units of formula I:

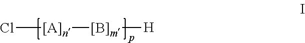

in which:

A is

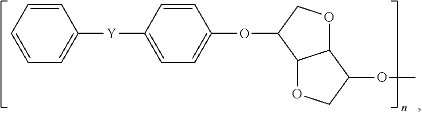

, where Y is CO or SO₂ and n is an integer greater than 1,

B is

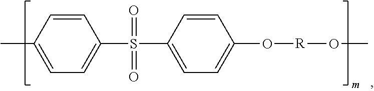

where R originates from an aliphatic or aromatic diol and m is an integer greater than 1,

n′ and m′ are each independently of each other an integer greater than 1, the molar ratio n′/m′ is between 1/99 and 99/1, and p is an integer greater than 1.

Another subject matter of the present invention relates to the use of the block copolymer capable of being obtained by the process according to the invention for the manufacture of membranes.

### DETAILED DESCRIPTION

The present invention relates to a process for the preparation of a block copolymer of aromatic polyethersulfone type comprising the following successive stages:
a) preparation of a first polymer block having the repeat unit:

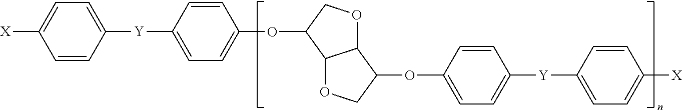

with a number-average molar mass Mn of between 1000 and 30 000 g/mol and where n is an integer greater than 1, X is Cl or F and Y is CO or SO₂,
the preparation of said first block consisting of the reaction between a 1,4:3,6-dianhydrohexitol and an excess of a dihalogenated bisaromatic compound chosen from 4,4′-dichlorodiphenyl sulfone, 4,4′-difluorodiphenyl sulfone, 4,4′-difluorodiphenyl ketone and 4,4′-dichlorodiphenyl ketone in the presence of a base in an organic solvent,
b) preparation of a second polymer block having the repeat unit:

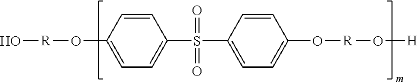

with a number-average molar mass Mn of between 1000 and 30 000 g/mol and where m is an integer greater than 1 and R originates from an aromatic or aliphatic diol,
the preparation of this second block consisting of the reaction between an aromatic or aliphatic diol in excess or in a stoichiometric amount with 4,4′-dichlorodiphenyl sulfone or 4,4′-difluorodiphenyl sulfone in the presence of a base in an organic solvent and optionally a cosolvent,
c) reaction between the first block and the second block according to block copolymerization in two successive stages or block copolymerization in two distinct stages.

The term “1,4:3,6-dianhydrohexitol” is understood to mean, within the meaning of the present invention, a heterocyclic compound obtained by double dehydration of a hexitol, such as mannitol, sorbitol and iditol. 1,4:3,6-Dianhydrohexitols exist mainly in the form of stereoisomers: isomannide, isosorbide and isoidide. 1,4:3,6-Dianhydrohexitol is used in the present invention as monomer for the formation of the first polymer block. Preferably, the 1,4:3,6-dianhydrohexitol used in the stage of preparation of the first polymer block is isosorbide.

For the first block, the aromatic dihalogen compound is advantageously chosen from dihalogenated aromatic sulfones or dihalogenated aromatic ketones. The aromatic dihalogen compounds used can be 4,4′-dichlorodiphenyl sulfone, 4,4′-difluorodiphenyl sulfone, 4,4′-dichlorodiphenyl ketone and 4,4′-difluorodiphenyl ketone. Preferably, the aromatic dihalogen compound used in the stage of preparation of the first polymer block is 4,4′-dichlorodiphenyl sulfone.

For the second block, the diol is advantageously chosen from aromatic diols and aliphatic diols. The preferred aromatic diols for the invention are known to a person skilled in the art and advantageously correspond to the following list:

dihydroxybenzenes, in particular hydroquinone and resorcinol;

dihydroxynaphthalenes, in particular 1,5-dihydroxynaphthalene, 1,6-dihydroxynaphthalene, 1,7-dihydroxynaphthalene and 2,7-dihydroxynaphthalene;

dihydroxybiphenyls, in particular 4,4′-biphenol and 2,2′-biphenol; biphenyl ethers, in particular bis(4-hydroxyphenyl) ether and bis(2-hydroxyphenyl) ether;

bisphenylpropanes, in particular 2,2-bis(4-hydroxyphenyl)propane, 2,2-bis(3-methyl-4-hydroxyphenyl)propane and 2,2-bis(3,5-dimethyl-4-hydroxyphenyl)propane;

bisphenylmethanes, in particular bis(4-hydroxyphenyl)methane;

bisphenylcyclohexanes, in particular bis(4-hydroxyphenyl)-2,2,4-trimethylcyclohexane; bisphenyl sulfones, in particular bis(4-hydroxyphenyl) sulfone;

bisphenyl sulfides, in particular bis(4-hydroxyphenyl) sulfide;

bisphenyl ketones, in particular bis(4-hydroxyphenyl) ketone;

bisphenylhexafluoropropanes, in particular 2,2-bis (3,5 -dimethyl-4-hydroxyphenyl)hexafluoropropane; and bisphenylfluorenes, in particular 9,9-bis(4-hydroxyphenyl)fluorene.

The aliphatic diol can be chosen from the following list: spiroglycol, tricyclo[5.2.1.0^{2,6}]decanedimethanol (TCDDM), 2,2,4,4-tetramethyl-1,3-cyclobutanediol, tetrahydrofurandimethanol (THFDM), furandimethanol, 1,2-cyclopentanediol, 1,3-cyclopentanediol, 1,2-cyclohexanediol, 1,4-cyclohexanediol, 1,2-cycloheptanediol, 1,5-naphthalenediol, 2,7-naphthalenediol, 1,4-naphthalenediol, 2,3-naphthalenediol, 2-methyl-1,4-naphthalenediol, 1,4-benzyldiol, octahydronaphthalene-4,8-diol, dioxane glycol (DOG), norbornanediols, adamanthanediols and pentacyclopentadecanedimethanols. Preferably, the diol used in the stage of preparation of the second polymer block is bisphenol A.

Advantageously, the process of the invention makes it possible to control the molar ratio of the 1,4:3,6-dianhydrohexitol to bisphenol A so as to obtain polymers exhibiting a high hydrophilicity and/or good permeability properties.

The first stage of the process thus consists in preparing a first polymer block having the repeat unit:

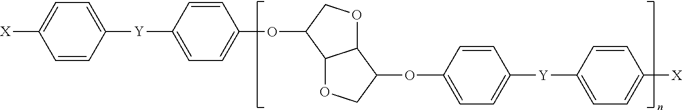

with a number-average molar mass Mn of between 1000 and 30 000 g/mol and where n is an integer greater than 1, X is Cl or F and Y is CO or SO₂, the preparation of said first block consisting of the reaction between a 1,4:3,6-dianhydrohexitol and an excess of 4,4′-dichlorodiphenyl sulfone or of 4,4′-difluorodiphenyl sulfone or of 4,4′-difluorodiphenyl ketone or of 4,4′-dichlorodiphenyl ketone in the presence of a base in an organic solvent.

The reaction between the 1,4:3,6-dianhydrohexitol and 4,4′-dichlorodiphenyl sulfone or 4,4′-difluorodiphenyl sulfone or 4,4′-difluorodiphenyl ketone or 4,4′-dichlorodiphenyl ketone is carried out in the presence of a base in an organic solvent and makes it possible to form the first block with halogenated ends.

The base is advantageously chosen from alkali metal salts. The bases can be chosen from the following list: potassium carbonate (K₂CO₃), sodium carbonate (Na₂CO₃), cesium carbonate (CsCO₃), lithium carbonate (LiCO₃), potassium tert-butoxide, potassium bis(trimethyl)silanolate, sodium methoxide, potassium methoxide, potassium bis(trimethylsilyl)amide, sodium hydroxide, potassium hydroxide or a mixture of these.

Preferably, the base is chosen from potassium carbonate (K₂CO₃) and sodium carbonate (Na₂CO₃).

Advantageously, the proportion of base is between 1 and 3 molar equivalents with respect to the amount of 1,4:3,6-dianhydrohexitol. Preferably, the proportion of base is approximately 2 molar equivalents with respect to the amount of 1,4:3,6-dianhydrohexitol.

The organic solvent of the stage of preparation of the first polymer block is advantageously chosen from polar aprotic solvents or a mixture of polar aprotic solvents. The term “polar aprotic solvent” is understood to mean, within the meaning of the present invention, a solvent having a dipole moment without an acidic hydrogen atom, that is to say a hydrogen atom bonded to a heteroatom. Preferably, the solvent is chosen from polar aprotic solvents containing a sulfur. Among the polar aprotic solvents containing a sulfur, preferably dimethyl sulfoxide, sulfolane, dimethyl sulfone, diphenyl sulfone, diethyl sulfoxide, diethyl sulfone, diisopropyl sulfone, tetrahydrothiophene-1-monoxide and mixtures of these. Polar aprotic solvents containing a nitrogen, such as dimethylacetamide, dimethylformamide, N-methyl-2-pyrrolidone, N-cyclohexyl-2-pyrrolidone or a mixture of these, can be used in the invention. More preferably, the solvents are dimethyl sulfoxide or N-methyl-2-pyrrolidone.

In a particularly preferred embodiment, the 1,4:3,6-dianhydrohexitol used in the stage of preparation of the first polymer block is isosorbide.

The isosorbide used for the preparation of the first block can be provided in the solid form, in particular in the powder, granule or flake form, or else in the molten form. Preferably, the isosorbide is provided in the solid form.

The reaction between the 1,4:3,6-dianhydrohexitol and 4,4′-dichlorodiphenyl sulfone or 4,4′-difluorodiphenyl sulfone or 4,4′-difluorodiphenyl ketone or 4,4′-dichlorodiphenyl ketone is advantageously carried out in the presence of a molar excess of 4,4′-dichlorodiphenyl sulfone. In other words, the amount of 4,4′-dichlorodiphenyl sulfone is greater than 1 molar equivalent with respect to the amount of 1,4:3,6-dianhydrohexitol. Preferably, the amount of 4,4′-dichlorodiphenyl sulfone is between 1.01 and 1.5 molar equivalents, more preferably between 1.05 and 1.25 molar equivalents, with respect to the amount of 1,4:3,6-dianhydrohexitol. More preferentially still, the amount of 4,4′-dichlorodiphenyl sulfone is approximately 1.076 molar equivalents with respect to the amount of 1,4:3,6-dianhydrohexitol.

Thus, the first polymer block is formed by reaction between the 1,4:3,6-dianhydrohexitol and 4,4′-dichlorodiphenyl sulfone or 4,4′-difluorodiphenyl sulfone or 4,4′-difluorodiphenyl ketone or 4,4′-dichlorodiphenyl ketone as monomers. Advantageously, the total proportion of monomers, that is to say the sum of the amount of 1,4:3,6-dianhydrohexitol and of the amount of 4,4′-dichlorodiphenyl sulfone, is between 10% and 50%, preferably between 20% and 40%, by weight with respect to the sum of the weight of the solvent and of the weight of the monomers. More preferably, the proportion of monomers is approximately 30% by weight with respect to the sum of the weight of the solvent and of the weight of the monomers.

In order to initiate the reaction between the 1,4:3,6-dianhydrohexitol and the dihalogenated bisaromatic compound in order to form the first polymer block, the reaction medium comprising the 1,4:3,6-dianhydrohexitol and the dihalogenated bisaromatic compound is heated. Advantageously, the stage of preparation of the first polymer block is carried out at a temperature of between 160° C. and 250° C., preferably between 180° C. and 250° C., preferably between 190° C. and 240° C., more preferably between 200° C. and 230° C., for a period of time of between 1 hour and 24 hours, preferably between 2 hours and 18 hours, more preferably between 3 hours and 12 hours. More preferentially still, the stage of preparation of the first polymer block is carried out at a temperature of approximately 210° C., for a period of time of approximately 7 hours 30 minutes.

After reaction, the temperature of the reaction medium is lowered to a temperature of between 90° C. and 150° C., preferably between 100° C. and 140° C., more preferably to a temperature of approximately 120° C., in order to stop the reaction.

The second stage of the process according to the invention consists in preparing a second polymer block having the repeat unit:

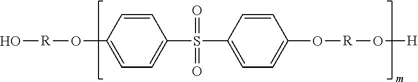

with a number-average molar mass Mn of between 1000 and 30 000 g/mol and where m is an integer of greater than 1 and R originates from an aromatic or aliphatic diol,
the preparation of this second block consisting of the reaction between an aromatic or aliphatic diol in excess or in a stoichiometric amount with 4,4′-dichlorodiphenyl sulfone or 4,4′-difluorodiphenyl sulfone in the presence of a base in an organic solvent and optionally a cosolvent.

According to a first specific embodiment, the preparation of the second polymer block is carried out in the same reaction medium as that used for the preparation of the first polymer block. This is referred to as “block copolymerization in two successive stages”. Thus, after lowering the temperature of the reaction medium for the preparation of the first polymer block, bisphenol A and 4,4′-dichlorodiphenyl sulfone or 4,4′-difluorodiphenyl sulfone are added with molar amounts known to a person skilled in the art in order to form the second polymer block. The molar ratio of bisphenol A to 4,4′-dichlorodiphenyl sulfone or 4,4′-difluorodiphenyl sulfone is preferentially between 1 and 1.2, in particular between 1 and 1.1 and more preferentially still between 1 and 1.05. Because of their low molar masses, the determination of the length of precursor oligomers is often subject to errors, which makes it impossible to observe a strict stoichiometry of the oligomers for the synthesis of the block copolymer in two distinct stages. According to the patent U.S. Pat. No. 8,759,458 B2, it is known that the copolymerization in two successive stages has the advantage of being able to control the stoichiometry and thus of obtaining higher molar masses.

The reaction between bisphenol A and 4,4′-dichlorodiphenyl sulfone or 4,4′-difluorodiphenyl sulfone is carried out in the presence of a base and in an organic solvent as well as a cosolvent and makes it possible to form the second block at the ends carrying a hydroxyl group.

The total amount of bisphenol A forming the second block can be varied with respect to the amount of 1,4:3,6-dianhydrohexitol used for the formation of the first block during the first stage of the process. Thus, the stage of preparation of the second polymer block is advantageously carried out with a 1,4:3,6-dianhydrohexitol/bisphenol A molar ratio of between 1/99 and 99/1, preferably between 10/90 and 90/10, more preferably between 20/80 and 80/20, more preferably between 40/60 and 60/40. More preferentially still, the 1,4:3,6-dianhydrohexitol/bisphenol A molar ratio is approximately 50/50.

The base is advantageously chosen from alkali metal salts. The bases can be chosen from the following list: potassium carbonate (K₂CO₃), sodium carbonate (Na₂CO₃), cesium carbonate (CsCO₃), lithium carbonate (LiCO₃), potassium tert-butoxide, potassium bis(trimethyl)silanolate, sodium methoxide, potassium methoxide, potassium bis(trimethylsilyl)amide, sodium hydroxide, potassium hydroxide or a mixture of these. Preferably, the base is chosen from potassium carbonate (K₂CO₃) and sodium carbonate (Na₂CO₃).

Advantageously, the proportion of base is between 1 and 3 molar equivalents with respect to the amount of bisphenol A. Preferably, the proportion of base is approximately 2. molar equivalents with respect to the amount of bisphenol A.

The organic solvent of the stage of preparation of the second polymer block is advantageously chosen from polar aprotic solvents. The term “polar aprotic solvent” is understood to mean, within the meaning of the present invention, a solvent having a dipole moment without an acidic hydrogen atom, that is to say a hydrogen atom bonded to a heteroatom. Preferably, the solvent is chosen from those containing a sulfur. Among the polar aprotic solvents containing a sulfur, preferably dimethyl sulfoxide, sulfolane, dimethyl sulfone, diphenyl sulfone, diethyl sulfoxide, diethyl sulfone, diisopropyl sulfone, tetrahydrothiophene-1-monoxide and mixtures of these. Polar aprotic solvents containing a nitrogen, such as dimethylacetamide, dimethylformamide, N-methyl-2-pyrrolidone, N-cyclohexyl-2-pyrrolidone or a mixture of these, are used in the invention. More preferably, the solvents are dimethyl sulfoxide or N-methyl-2-pyrrolidone.

The cosolvent is advantageously chosen from nonpolar solvents, such as n-hexane, cyclohexane, benzene, toluene or xylene. Preferably, the cosolvent is toluene.

Advantageously, the polar aprotic solvent/cosolvent molar ratio is between 0.1 and 10, preferably between 0.5 and 5, more preferably between 1 and 2. More preferentially still, the polar aprotic solvent/cosolvent molar ratio is approximately 1.5.

After addition of bisphenol A and 4,4′-dichlorodiphenyl sulfone or 4,4′-difluorodiphenyl sulfone, the reaction medium is maintained at a temperature of between 90° C. and 150° C., preferably between 100° C. and 140° C., more preferably at a temperature of approximately 120° C., in order to form the second polymer block, for a period of time of between 1 hour and 24 hours, preferably between 6 hours and 20 hours, more preferably between 12 hours and 18 hours, more preferentially still for a period of time of approximately 15 hours.

According to a second specific embodiment, the preparation of the second polymer block is carried out in a different medium from that used for the preparation of the first polymer block. This is referred to as “block copolymerization in two distinct stages”. Thus, bisphenol A and 4,4′-dichlorodiphenyl sulfone or 4,4′-difluorodiphenyl sulfone as monomers are reacted in the presence of a base in a polar aprotic solvent in order to form the second polymer block.

The third stage of the process according to the invention consists in reacting the first polymer block with the second polymer block in order to obtain the block copolymer.

According to a first embodiment of the invention, that is to say the “block copolymerization in two successive stages”, on conclusion of the second stage of the process, the first block and the second block are present in the same reaction medium. The third stage of the process consists in increasing the temperature of the reaction medium comprising the first block and the second block so that the two blocks react together.

Advantageously, the stage of reaction between the first block and the second block is carried out at a temperature of between 150° C. and 200° C., for a period of time of between 1 hour and 24 hours.

During the reaction, the viscosity of the reaction medium increases, meaning that the first and the second blocks are reacting together.

According to a second embodiment of the invention, that is to say the “block copolymerization in two distinct stages”, the third stage of the process consists in bringing the first polymer block obtained on conclusion of the first stage of the process into the presence of the second polymer block obtained on conclusion of the second stage of the process so that the first block and the second block react together.

Once the first block and the second block have been mixed, the stage of reaction between the first block and the second block is carried out at a temperature of between 150° C. and 200° C.

On conclusion of the reaction between the first block and the second block, the block copolymer obtained can be recovered by techniques known to a person skilled in the art, such as, for example, the precipitation of the reaction medium from a large volume of water, approximately 10 times the volume of the reaction medium. The block copolymer can subsequently be dried according to techniques known to a person skilled in the art, such as, for example, in an oven at 80° C. for 12 hours.

Thus, the invention also relates to a block copolymer of aromatic polyethersulfone type capable of being obtained by the process according to the invention.

This copolymer comprises the repeat units of formula I:

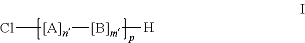

in which:

A is

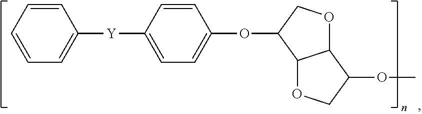

where Y is SO₂ or CO and n is an integer greater than 1,

B is

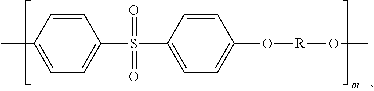

where R originates from an aliphatic or aromatic diol and m is an integer greater than 1,

n′ and m′ are each independently of each other an integer greater than 1, the molar ratio n′/m′ is between 1/99 and 99/1, and p is an integer greater than 1.

A particularly preferred block copolymer of formula I is that in which:

A is

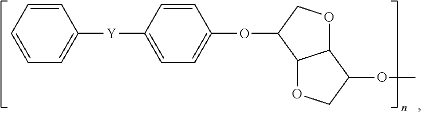

where Y is SO₂ or CO and n is an integer greater than 1,

and B is

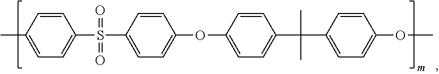

where R originates from an aliphatic or aromatic diol and m is an integer greater than 1.

Advantageously, the block copolymer capable of being obtained by the process according to the invention has a number-average molecular weight Mn of greater than 30 000 g/mol.

The block copolymer capable of being obtained by the process according to the invention exhibits a glass transition temperature of greater than 140° C., preferably of approximately 210° C.

Another subject matter of the present invention relates to the use of the block copolymer according to the invention for the manufacture of membranes, of manufactured components and of coating.

Membranes can be manufactured from the block copolymer of the invention according to techniques known to a person skilled in the art.

In particular, the membranes obtained with the block copolymer according to the invention exhibit advantageous properties of hydrophilicity and of permeability to gases. The membranes can exist in the form of porous or nonporous films. The membranes can be manufactured in the form of a monofilament or of hollow fibers. The composition of the block copolymer according to the invention can be used in aqueous media, including body fluids. The block copolymer according to the invention is biocompatible and can thus be used in the form of a membrane in the medical field, such as for hemodialyses, in the consumer field (food and beverages) or in the field of wastewater treatment. Porous membranes in the form of tubes or of hollow fibers can exhibit different sizes of pores known to a person skilled in the art depending on their application (microfiltration, ultrafiltration, nanofiltration, reverse osmosis). The performance qualities of the aqueous membranes obtained with the block copolymer according to the invention can be improved by techniques known to a person skilled in the art, in particular the use of sulfonated monomers or the post-treatment of the membranes by sulfonation or by surface treatment to prevent clogging.

Gas-phase membranes can be used for the production of nitrogen from the separation of the nitrogen and oxygen mixture of the air or the production of methane from the separation of methane and CO₂. The performance qualities of the gas membranes obtained with the block copolymer according to the invention can be improved by techniques known to a person skilled in the art, in particular the use of hindered monomers or the addition of additives, such as bisphenols, which are substituted, naphthalenes or fluorenes, or also the use of thermally labile compounds in order to form pores.

The membranes in the form of films or of sheets can be used for optics or for packaging.

Molded components can be manufactured from the block copolymer of the invention according to techniques known to a person skilled in the art. The injection molding of the block copolymer according to the invention can result in the production of components used in the health sector, with dental applications for replacing metals, glass and other disposable or reusable utensils, but also in aeronautics, electronics and the automotive sector.

Another subject matter of this invention is the use of the block copolymer as resin for the coating of metals in order to prevent corrosion. The coating starting from the block copolymer according to the invention can be applied to steel, aluminum, copper, metals used in the consumer sector (food and drink), the nautical sector, with the hulls of boats, the aerospace sector, the automotive sector, the electrical sector, with cables, and the electronics sector, with circuits. The resin of the block copolymer according to the invention can also be applied to other substrates, such as carbon fiber or glass, in order to form a composite after evaporation of the solvent from the resin. The composites formed from the resin of the block copolymer according to the invention can be used in the aerospace and automotive fields to replace metal components.

An even better understanding of the invention will be obtained on reading the figures and examples which follow, which are intended to be purely illustrative and do not in any way limit the scope of the protection.

### FIGURES

FIG. 1. Photograph of a membrane obtained with the block copolymer according to the invention example 1

FIG. 2. Differential scanning calorimetry carried out at 10° C./min from 20° C. to 300° C.

### EXAMPLES

### Example 1

Preparation of a block copolymer according to the invention in which the 1,4:3,6-dianhydrohexitol/bisphenol A ratio is 50/50.

0.7313 g (5 mmol, 1 eq.) of isosorbide, 1.5606 g (5.38 mmol, 1.076 eq.) of 4,4′-dichlorodiphenyl sulfone (DCDPS) and 1.3961 g (10 mmol, 2 eq.) of K₂CO₃ are dissolved in 5.31 g of DMS 0 in a three-necked flask equipped with a swan neck, a stirrer and a nitrogen inlet. A reflux condenser is fitted in order to condense the DMSO. The round-bottomed flask is heated with an oil bath at 210° C. for 7 h 30. The temperature is subsequently brought back to 120° C.

Subsequently, 1.1533 g (5 mmol, 1 eq.) of bisphenol A (BPA), 1.4509 g (5 mmol, 1 eq.) of 4,4′-dichlorodiphenyl sulfone (DCDPS) and 1.3963 g (10 mmol, 2 eq.) of K₂CO₃ (99%) in 12.71 g of NMP and 8.47 g of toluene are added. A Dean-Stark apparatus is fitted in order to form the water-toluene azeotrope. The medium is left at 120° C. for 15 h, then at 160° C. for 3 h 30 and finally at 180° C. for 4 h.

The reaction medium is poured into water, bringing about the precipitation of the polymer, which is subsequently filtered off and then dried at 80° C. for 16 h. The polymer is subsequently dissolved in 20 ml of DMSO and reprecipitated from a large volume of water, filtered off and dried under vacuum at 40° C. for 16 h.

### Counterexample 2

This example is a polyethersulfone purchased from Acros Organics 178910050 in the form of transparent granules. The product has not undergone any treatment. This product is a polyethersulfone which is devoid of isosorbide but containing bisphenol A.

### Counterexample 3

This comparative example corresponds to example No. 5 of the patent WO2014/072473 of Solvay Specialty Polymers, USA, carried out in DMSO as reaction solvent. It is a polyethersulfone homopolymer starting from isosorbide.

### Counterexample 4

This comparative example corresponds to example No. 5 of the patent WO2016/032179 of Samyang Corporation, carried out in DMSO as reaction solvent without chlorobenzene as cosolvent. It is a statistical copolymer of polyethersulfone based on isosorbide and on bisphenol A with the isosorbide/bisphenol A molar ratio of 50/50.

### Counterexample 5

This example corresponds to a mixture of counterexample 2 with counterexample 3 dissolved in DMSO at 20% by weight and then precipitated from water. The mixture is subsequently dried at 80° C. for 16 h.

The characterizations applied to the examples are described below:
Nuclear Magnetic Resonance (NMR). The 100 MHz ¹³C spectra were produced on a BrUker Ascend™ 400 in a 5 mm glass tube in d₆-DMSO.
Differential scanning calorimetry (DSC) (FIG. 2) The differential scanning calorimetry analysis was carried out on a DSC-Q5000 SA, TA Instruments, USA, with a flow rate of 50 ml/min in nitrogen at 10° C./min or 20° C./min from 20° C. to 300° C. and in a drilled aluminum crucible.
Size-Exclusion Chromatography (SEC): The analysis of the molar masses was carried out by size-exclusion chromatography with an Agilent PLgel 5 μm column in DMF/LiBr at 50° C. for 35 min with a flow rate of 0.5 ml/min and in PS calibration.

TABLE 1

| Analyses | | | | Ability to |
|---|---|---|---|---|
| Examples | Mₙ¹ (g/mol) | PI | Tg¹ (° C.) | form films |
| Example 1 | 80 000 | 1.6 | 200 | Yes |
| Counterexample 2 | 90 000 | 1.6 | 190 | Yes |
| Counterexample 3 | 34 000 | 1.2 | 200 | No |
| Counterexample 4 | 30 000 | 1.1 | 150 | No |

¹DSC: Heating/cooling/heating cycle from 20° C. to 300° C. at 20° C./min, drilled aluminum crucible

¹³C NMR proves a level of incorporation of 56% of isosorbide with respect to the total level of diols incorporated.

With SEC, a single Gaussian curve of 80 000 g/mol in polystyrene calibration is observed. The molar mass Mn of the block copolymer according to the invention, example 1, is higher than that of the isosorbide-based homopolymer, counterexample 3, and than that of the 50/50 isosorbide/bisphenol A statistical copolymer, counterexample 4, respectively 34 000 and 30 000 g/mol. The DSC analysis (FIG. 2) shows that the block copolymer according to the invention, example 1, has a single Tg at 192° C. The mixture of the isosorbide-based homopolymer, counterexample 3 (C3 in FIG. 2), and commercial PES, counterexample 2 (C2 in FIG. 2), exhibits two Tg values at 183° C. and 208° C. (counterexample 5; C4 in FIG. 2). These two analyses are in agreement with the block nature of the polymer of the invention and refute the hypothesis of the formation of two homopolymers, one based on isosorbide and the other based on bisphenol A.

Particularly advantageously, the copolymer according to the invention exhibits an average molecular weight comparable to that of the market reference. It is a high weight, in particular in the sense that it is greater than 50 000 g/mol, and thus makes said copolymer capable of being used for the manufacture of membranes.

Preparation of a Membrane

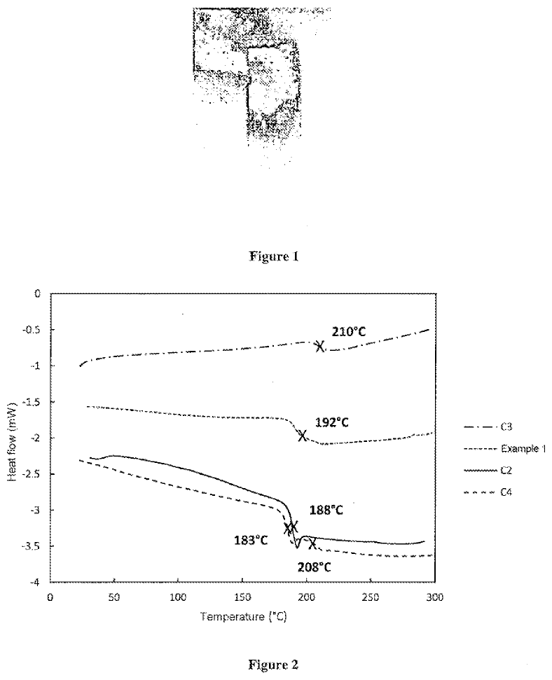

A membrane can be prepared from a 20% by weight solution of the polymer in NMP poured onto a glass sheet. The solvent is subsequently evaporated using the following thermal cycle: 70° C. for 2 h, 120° C. for 1 h, 150° C. for 1 h and 200° C. for 1 h. After curing, a transparent brown membrane is obtained for example 1 (FIG. 1). A membrane is also obtained with counterexample 2.

The copolymer of the invention is film-forming, unlike counterexamples 3 and 4 of the literature.

The characterizations applied to the two membranes are described below:

Contact Angle

The contact angle was measured with water and diiodomethane according to the Owens, Wendt, Rabel and Kaelble model.

Dynamic Sorption

The water uptake measurement was carried out with a Dynamic Vapor Sorption device (DVS Q-5000 SA, TA Instruments) at atmospheric pressure and at the isotherm of 21° C. with a sorption/desorption cycle from 0% to 90% humidity.

Permeability

The experiments are carried out at ambient temperature. The handling operation consists in inserting the film to be studied into the permeation cell. After a high-vacuum desorption of 16 h, the permeation experiment consists in imposing a pressure (3 bar) of a chosen gas in the upstream compartment of the cell and in measuring the pressure rise in the downstream compartment of the cell. The permeability is calculated from the slope of the straight pressure line as a function of time under stationary conditions, corrected if necessary for the static vacuum.

TABLE 2
Analyses obtained on the membranes
Hydrophilicity properties

| | Contact angle H₂O | 50% Sorption |
|---|---|---|
| | (°) | (g of water/g sample) |
| Example 1 | 89.03 | 0.89% |
| Counterexample 2 | 89.20 | 0.39% |

Permeability properties

| | P(He) | P(CO₂) | P(O₂) | Selectivity | Selectivity |
|---|---|---|---|---|---|
| | (Barrer) | (Barrer) | (Barrer) | He/CO₂ | CO₂/O₂ |
| Counterexample 2 | 12.4 | 6.1 | 2.65 | 2.03 | 2.30 |
| Example 1 | 8.3 | 2.93 | 0.5 | 2.83 | 5.86 |

In short, from these analyses, the selectivity for certain gases is improved. For example, in a particularly advantageous and discriminating manner, the CO₂/O₂ selectivity changes from 2.30 for counterexample 2 to 5.86 for example 1. More significantly still, and more advantageously still, the hydrophilic nature is much more important for the product according to the invention: the water absorption is more than 2 times greater than that observed for the commercial product. This property is particularly advantageous for a membrane, the ability of which to rapidly hydrate will condition its yield and its efficiency.

1. A process for the preparation of a block copolymer of aromatic polyether type comprising the following successive stages:
a) preparation of a first polymer block having the repeat unit: 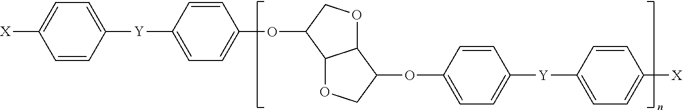
with a number-average molar mass Mₙ of between 1000 and 30 000 g/mol and
where n is an integer greater than 1, X is Cl or F and Y is CO or SO₂,
the preparation of said first block consisting of the reaction between a 1,4:3,6-dianhydrohexitol and an excess of a halogenated bisaromatic compound chosen from 4,4′-dichlorodiphenyl sulfone, 4,4′-difluorodiphenyl sulfone, 4,4′-difluorodiphenyl ketone and 4,4′-dichlorodiphenyl ketone in the presence of a base in an organic solvent,
b) preparation of a second polymer block having the repeat unit: 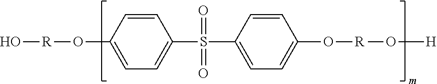
with a number-average molar mass Mn of between 1000 and 30 000 g/mol and where m is an integer of greater than 1 and R originates from an aromatic or aliphatic diol,
the preparation of this second block consisting of the reaction between an aromatic or aliphatic diol in excess or in a stoichiometric amount with 4,4′-dichlorodiphenyl sulfone or 4,4′-difluorodiphenyl sulfone in the presence of a base in an organic solvent and optionally a cosolvent,
c) reaction between the first block and the second block according to block copolymerization in two successive stages or block copolymerization in two distinct stages.

2. The process as claimed in claim 1, wherein the organic solvent of the stage of preparation of the first polymer block is a polar aprotic solvent.

3. The process as claimed in claim 1, wherein the 1,4:3,6-dianhydrohexitol used in the stage of preparation of the first polymer block is isosorbide.

4. The process as claimed in claim 1, wherein the proportion of monomers is between 10% and 50% by weight with respect to the sum of the weight of the solvent and of the weight of the monomers.

5. The process as claimed in claim 1, wherein the stage of preparation of the first polymer block is carried out at a temperature of between 160° C. and 250° C.

6. The process as claimed in claim 1, wherein the preparation of the first polymer block and the preparation of the second polymer block are carried out in the same reaction medium.

7. The process as claimed in claim 1, wherein the stage of preparation of the second block is carried out with a 1,4:3,6-dianhydrohexitol/bisphenol A molar ratio of between 1/99 and 99/1.

8. The process as claimed in claim 1, wherein the organic solvent of the stage of preparation of the second polymer block is a polar aprotic solvent.

9. The process as claimed in claim 1, wherein the polar aprotic solvent/cosolvent molar ratio is between 0.1 and 10.

10. The process as claimed in claim 1, wherein the stage of preparation of the second polymer block is carried out at a temperature of between 90° C. and 150° C.

11. The process as claimed in 1, wherein the stage of reaction between the first block and the second block is carried out at a temperature of between 150° C. and 200° C.

12. A block copolymer of aromatic polyether type comprising the repeat units of the formula I: 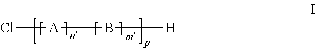
in which:
A is 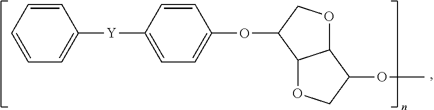
where Y is CO or SO₂ and n is an integer greater than 1,
B is 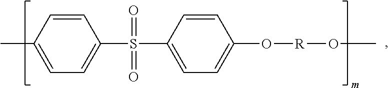
where R originates from an aliphatic or aromatic diol and m is an integer greater than 1,
n′ and m′ are each independently of each other an integer greater than 1, the molar ratio n′/m′ is between 1/99 and 99/1, and p is an integer greater than 1.

13. The block copolymer as claimed in claim 12, in which the average molecular weight is greater than 30 000 g/mol.

14. The use of a block copolymer capable of being obtained by the process as claimed in claim 1 or of the copolymer as claimed in claim 12 for the manufacture of membranes.
